(19) United States
(12) Patent Application Publication
(10) Pub. No.: US 2005/0206089 A1
(43) Pub. Date: Sep. 22, 2005

(54) Hermetic washer for a pneumatic cylinder

(76) Inventor: Tsen-Hsuan Chen, Tainan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/883,662

(22) Filed: Jul. 6, 2004

(30) Foreign Application Priority Data
Mar. 18, 2004 (TW) 093204077

(51) Int. Cl. F16J 15/32

(52) U.S. Cl. 277/549

(57) ABSTRACT

A hermetic washer has an annular body and a collar. The annular body is made of elastic material and has an outer surface, a bottom, multiple outer flanges and an inner sleeve. The inner sleeve is defined in a center of the annular body and has a lower end, a through hole, an inner surface and multiple inner flanges. The through hole is defined through the inner sleeve. The collar is made of metal and is mounted on the bottom of the annular body around the lower end of the inner sleeve. The hermetic washer has an improved hermetic effect.

### BACKGROUND OF THE INVENTION

1. Field of the Invention

The present invention relates to a hermetic seal, and more particularly to a hermetic seal for a pneumatic cylinder.

2. Description of Related Art

In general, cylinders are classified into several types and one of the types of cylinders is a pneumatic type.

The pneumatic cylinder has a simple structure and is widely used in furniture, medical appliances, bicycles, motorcycles, vehicles etc. For example, a height-adjustable chair, as used in offices, can have a pneumatic cylinder to appropriately position the seat of the chair.

With reference to FIGS. 6 and 7, a pneumatic cylinder is applied to a height-adjustable chair. The height-adjustable chair has a seat (not numbered). The pneumatic cylinder is mounted under the seat of the chair. The height of the seat is adjustable with the operation of the pneumatic cylinder.

The pneumatic cylinder comprises a pneumatic cylinder body (30) and a piston rod (40) and a conventional hermetic seal (50) in accordance with the prior art is applied to the pneumatic cylinder.

The cylinder body (30) has an outer tube (32), an inner tube (31), an annular passage (38), a head (33), a shaft (34) and a handle (35).

The outer tube (32) has an upper end (not numbered), a lower end (not numbered) and an inner face (not numbered).

The inner tube (31) is inserted into the outer tube (32) and has an upper end (not numbered), a lower end (not numbered), an outer surface (not numbered) and an air chamber (311).

The annular passage (38) is defined between the inner surface of the outer tube (32) and the outer surface of the inner tube (31).

The head (33) is mounted between the inner surface of the outer tube (32) and the upper end of the inner tube (31), and is connected hermetically to the upper end of the inner tube (31). The head (33) has a base (not numbered), an enclosure (not numbered), a through hole (not numbered), a lower opening (not numbered) and an upper passage (37). The enclosure extends from the base and has a distal end (not numbered). The through hole is defined inside the enclosure through the base and is communicated with the air chamber (311). The lower opening is defined at the distal end of the enclosure and is communicated with the through hole. The upper passage (37) is defined through the enclosure and is communicated respectively with the through hole and the annular passage (38).

The shaft (34) extends through the upper end of the outer tube (32) and the head (33) and is mounted slidably inside the through hole of the head (33). The shaft (34) has an upper end (not numbered), a lower end (not numbered) and a valve (36). The upper end of the shaft (34) is connected to the handle (35). The valve (36), attached to the lower end of the shaft (34), is in contact with the distal end of the enclosure of the head (33) and seals the opening of the head (33).

The handle (35) is connected to the upper end of the shaft (34) and drives the shaft (34) to slide inside the head (33).

The piston rod (40) is slidably mounted inside the cylinder body (30) and has a top end (not numbered), a piston (41), a bottom seat (42) and a fixing member (43). The piston (41) is mounted at the top end of the piston rod (40) inside the inner tube (31). The bottom seat (42) is mounted around the piston rod (40) and connected to the lower end of the inner tube (31) and has an upper end (not numbered), a lower end (not numbered) and a lower passage (39). The lower passage (39) is defined in the upper end of the bottom seat (42) and is communicated with the annular passage (38). The fixing member (43) is mounted at the lower end of the outer tube (32).

The conventional hermetic seal (50) in accordance with the prior art is mounted between the fixing member (43) and the bottom seat (42), is made of elastic material and has an annular body (51) and a collar (60). The annular body (51) has an outer surface (not numbered), a bottom (not numbered), an outer flange (511) and an inner sleeve (52). The outer flange (511) resiliently abuts the outer tube (32). The inner sleeve (52) is defined in the center of the annular body (51) and has a lower end (not numbered), a through hole (53), an inner surface (not numbered) and an inner flange (521). The through hole (53) is defined through the inner sleeve (52). The inner flange (521) has a sharp tooth-like cross section and resiliently abuts the piston rod (40). The collar (60) is mounted on the bottom of the annular body (51) and around the lower end of the inner sleeve (52).

Before the fixing member (43) is mounted in the cylinder body (30), the handle (35) is pivoted upwards to move the shaft (34) downwards to open the valve (36). Thus, the air chamber (311), the upper passage (37), the annular passage (38), and the lower passage (39) are communicated with each other. Air is pumped into the air chamber (311) and the passages (37, 38, 39) through the conventional hermetic seal (50).

When the air passes through the conventional hermetic seal (50), the sleeve (52) and collar (60) are pressed outwards to define a clearance between the piston rod (40) and the opening (53), and air passes through the clearance in the cylinder (30). When filling is completed, the clearance will be eliminated by the contraction of the inner flange (521) under the resilient force of the sleeve (52) and collar (60) to prevent the air in the air chamber (311) from leaking out. Thereafter, the fixing member (43) is positioned to complete assembling of the pneumatic cylinder.

When the handle (35) is pivoted upwards to open the valve (36) and the seat is pressed downward with an external force, the valve (36) is moved downward and the through hole of the head (33) is communicated with the air chamber (311.) The air in the air chamber (311) flows through the upper passage (37), the annular passage (38), and into the lower passage (39). Thus, the piston (41) is pushed upwards by the compressed air to lower the seat.

However, all the contacts between the inner flange (521) and the piston rod (40), and between the outer flange (511) and the outer tube (32) are single-line contacts with a low reliability. The air in the air chamber (311) easily leaks out from the inner flange (521) and outer flange (511).

Therefore, the invention provides a hermetic seal for a pneumatic cylinder to mitigate or obviate the aforementioned problems.

### SUMMARY OF THE INVENTION

The main objective of the present invention is to provide a hermetic seal for a pneumatic cylinder having an improved hermetic effect.

A hermetic seal for a pneumatic cylinder in accordance with the present invention comprises an annular body and a collar.

The annular body is made of elastic material and has an outer surface, a bottom, multiple outer flanges and an inner sleeve. The inner sleeve is defined in the center of the annular body and has a lower end, a through hole, an inner surface and multiple inner flanges. The through hole is defined through the inner sleeve.

The collar is made of metal and is mounted on the bottom of the annular body around the lower end of the inner sleeve.

Other objectives, advantages and novel features of the invention will become more apparent from the following detailed description when taken in conjunction with the accompanying drawings.

### BRIEF DESCRIPTION OF THE DRAWINGS

FIG. 1 is a cross sectional view of a first embodiment of a hermetic seal for a pneumatic cylinder in accordance with the present invention;

FIG. 2 is a cross sectional view of a second embodiment of a hermetic seal for a pneumatic cylinder in accordance with the present invention;

FIG. 3 is a cross sectional view of a third embodiment of a hermetic seal for a pneumatic cylinder in accordance with the present invention;

FIG. 4 is a front view in partial cross section of a pneumatic cylinder with the hermetic seal in FIG. 1;

FIG. 5 is an enlarged front view of the pneumatic cylinder with the hermetic seal in FIG. 4;

FIG. 6 is a front view in partial cross section of a pneumatic cylinder with a conventional hermetic seal in accordance with the prior art; and

FIG. 7 is a cross sectional view of the conventional hermetic seal in FIG. 6.

### DETAILED DESCRIPTION OF THE PREFERRED EMBODIMENT

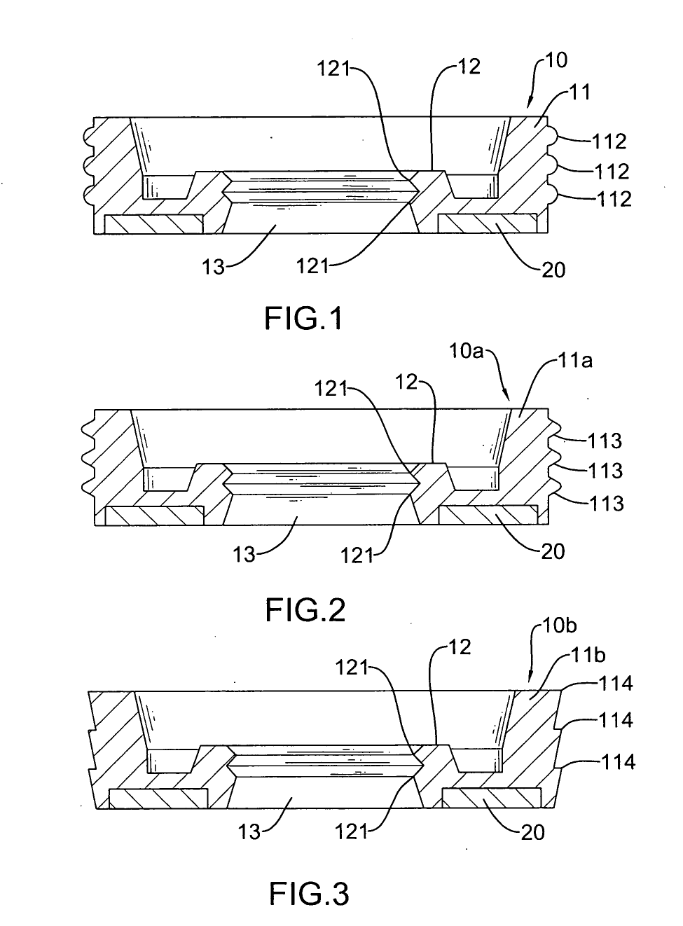

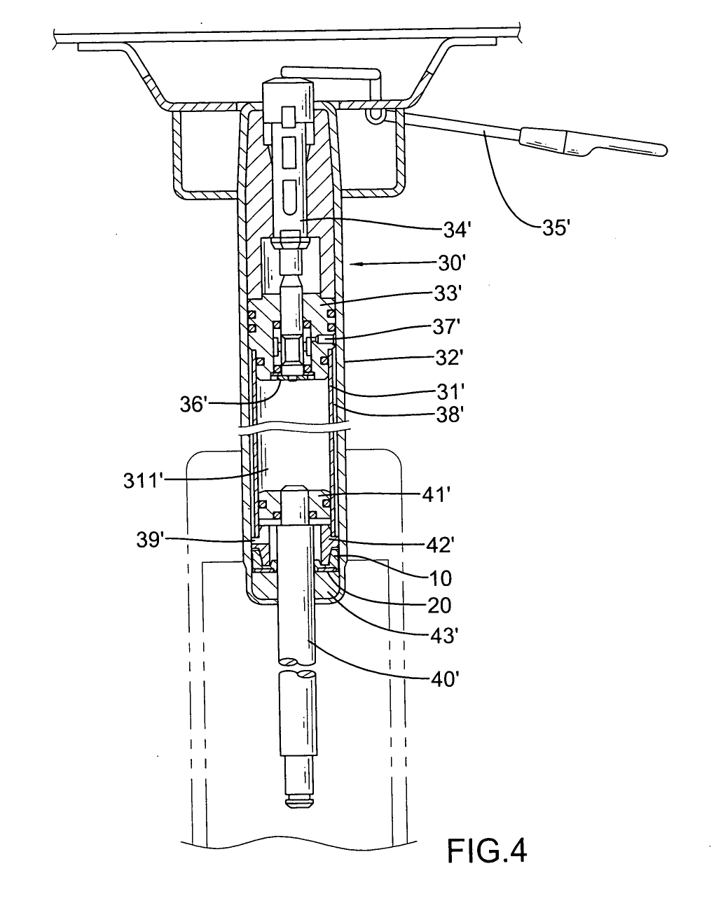

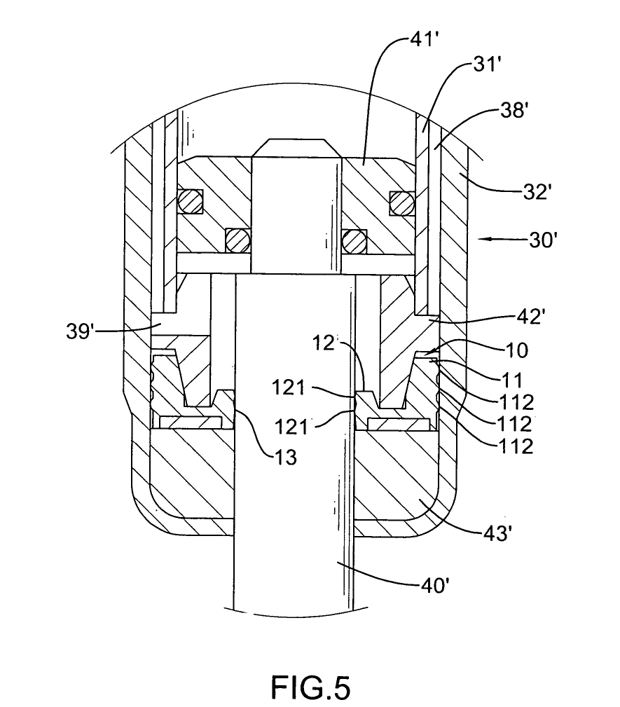

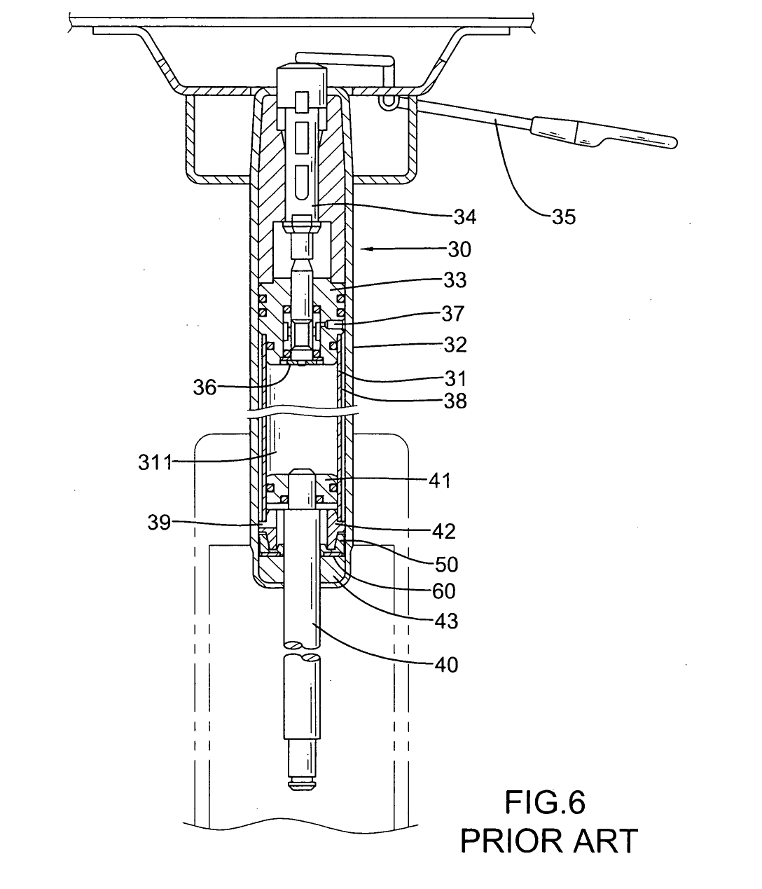

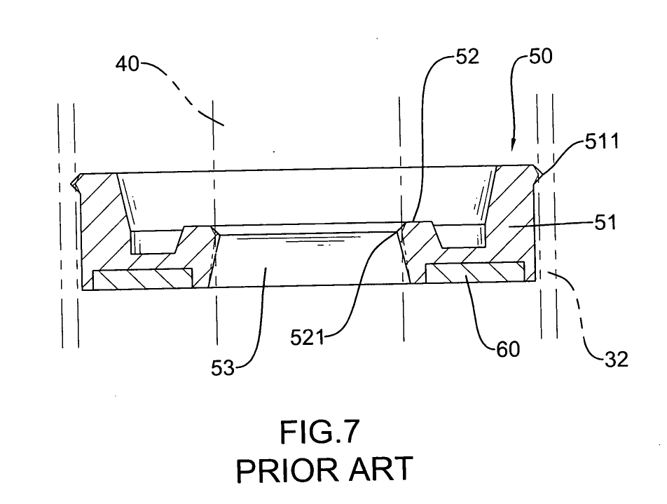

With reference to FIGS. 1, 4 and 5, a hermetic seal (10) for a pneumatic cylinder in accordance with the present invention is mounted inside a pneumatic cylinder similar with that described in the description of related art. The pneumatic cylinder has a pneumatic cylinder body (30′) and a piston rod (40′).

The cylinder body (30′) has an outer tube (32′), an inner tube (311′), an annular passage (38′), a head (33′), a shaft (34′) and a handle (35′).

The outer tube (32′) has an upper end (not numbered), a lower end (not numbered) and an inner face (not numbered). The inner tube (31′) is inserted into the outer tube (32′) and has an upper end (not numbered), a lower end (not numbered), an outer surface (not numbered) and an air chamber (31′). The annular passage (38′) is defined between the inner surface of the outer tube (32′) and the outer surface of the inner tube (31′).

The head (33′) is mounted between the inner surface of the outer tube (32′) and the upper end of the inner tube (31′), and is connected hermetically to the upper end of the inner tube (31′). The head (33) has a base (not numbered), an enclosure (not numbered), a through hole (not numbered), a lower opening (not numbered) and an upper passage (37′). The enclosure extends from the base and has a distal end (not numbered). The through hole is defined inside the enclosure through the base and is communicated with the air chamber (311′). The opening is defined at the distal end of the enclosure and is communicated with the through hole. The upper passage (37′) is defined through the enclosure and is communicated respectively with the through hole and the annular passage (38′).

The shaft (34′) extends through the upper end of the outer tube (32′) and the head (33′) and is mounted slidably inside the through hole of the head (33′). The shaft (34′) has an upper end (not numbered), a lower end (not numbered) and a valve (36′).

The piston rod (40′) is slidably mounted inside the cylinder body (30′) and has a top end (not numbered), a piston (41′), a bottom seat (42′) and a fixing member (43′). The piston (41′) is formed at the top end of the piston rod (40′) inside the inner tube (31′). The bottom seat (42′) is mounted around the piston rod (40′) and connected to the lower end of the inner tube (31′), and has an upper end (not numbered), a lower end (not numbered) and a lower passage (39′). The lower passage (39′) is defined in the upper end of the bottom seat (42′) and is communicated with the annular passage (38′). The fixing member (43′) is mounted at the lower end of the outer tube (32′).

With reference to FIGS. 1 to 4, the hermetic seal (10, 10a, 10b) for a pneumatic cylinder in accordance with the present invention is mounted between the fixing member (43′) and the bottom seat (42′) inside the outer tube (32′), is connected to the lower end of the bottom seat (42′) and has an annular body (11, 11a, 11b) and a collar (20).

The annular body (11, 11a, 11b) is made of elastic material and has an outer surface, a bottom, multiple outer flanges (112, 113, 114) and an inner sleeve (12). The outer flanges (112, 113, 114) resiliently abut against the outer tube (32′). The inner sleeve (12) is defined in the center of the annular body (11, 11a, 11b) and has a lower end, a through hole (13), an inner surface and multiple inner flanges (121). The through hole (13) is defined through the inner sleeve (12). The inner flange (121) resiliently abuts against the piston rod (40′).

With reference to FIG. 1, in a first embodiment of the hermetic seal (10) for a pneumatic cylinder in accordance with the present invention, the quantity of the outer flanges (112) is three and each of the outer flanges (112) has a semi-circular cross section. The quantity of the inner flanges (121) is two and each of the inner flanges (121) has a sharp tooth-like cross section.

With reference to FIG. 2, in a second embodiment of the hermetic seal (10a) for a pneumatic cylinder in accordance with the present invention, the quantity of the outer flanges (113) is three and each of the outer flanges (113) has a V-shaped cross section with a round tip. The quantity of the inner flanges (121) is two and each of the inner flanges (121) has a sharp tooth-like cross section.

With reference to FIG. 3, in a third embodiment of the hermetic seal (10b) for a pneumatic cylinder in accordance with the present invention, the quantity of the outer flanges (114) is three and each of the outer flanges (114) has an inclined saw tooth-like cross section. The quantity of the inner flanges (121) is two and each of the inner flanges (121) has a sharp tooth-like cross section.

The collar (20) is made of metal and is mounted on the bottom of the annular body (11, 11a, 11b) and around the lower end of the inner sleeve (12) to restrict outward expansion of the inner sleeve (12).

The multiple inner flanges (121) of the inner sleeve (12) are in contact with the piston rod (40′) and reduce the leakage of the compressed air between the inner sleeve (12) and the piston rod (40′). The multiple outer flanges (112, 113, 114) are in contact with the outer tube (32′) and reduce the leakage of the compressed air between the annular body (11, 11a, 11b) and the inner surface of the outer tube (32). Therefore, the hermetic effect of the hermetic seal (10) for a pneumatic cylinder in accordance with the present invention is improved.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A hermetic seal comprising:
an annular body made of elastic material and having an outer surface;
a bottom;
multiple outer flanges; and
an inner sleeve defined in a center of the annular body and having:
a lower end;
a through hole defined through the inner sleeve;
an inner surface; and
multiple inner flanges; and
a collar made of metal and mounted on the bottom of the annular body around the lower end of the inner sleeve.

2. The hermetic seal as claimed in claim 1, wherein the quantity of the inner flanges is two and the quantity of the outer flange is three.

3. The hermetic seal as claimed in claim 1, wherein each of the inner flanges has a sharp tooth-like cross section and each of the outer flanges has a semi-circular cross section.

4. The hermetic seal as claimed in claim 2, wherein each of the inner flanges has a sharp tooth-like cross section and each of the outer flanges has a semi-circular cross section.

5. The hermetic seal as claimed in claim 1, wherein each of the inner flanges has a sharp tooth-like cross section and each of the outer flanges has a V-shaped cross section with a round tip.

6. The hermetic seal as claimed in claim 2, wherein each of the inner flanges has a sharp tooth-like cross section and each of the outer flanges has a V-shaped cross section with a round tip.

7. The hermetic seal as claimed in claim 1, wherein each of the inner flanges has a sharp tooth-like cross section and each of the outer flanges has an inclined saw tooth-like cross section.

8. The hermetic seal as claimed in claim 2, wherein each of the inner flanges has a sharp tooth-like cross section and each of the outer flanges has an inclined saw tooth-like cross section.
